(19) United States
(12) Patent Application Publication
(10) Pub. No.: US 2023/0145809 A1
(43) Pub. Date: May 11, 2023

(54) CABLE FOR ELECTRICALLY TRANSMITTING DATA

(71) Applicant: LEONI KABEL GMBH, Roth (DE)

(72) Inventors: ERWIN KOEPPENDOERFER, Schwabach (DE); DOMINIK DORNER, Weissenburg (DE); RAINER POEHMERER, Winkelhaid (DE); THORSTEN FINK, Nuernberg (DE); JOHANNES NACHTRAB, Windsbach (DE)

(21) Appl. No.: 17/918,387

(22) PCT Filed: Apr. 15, 2021
(86) PCT No.: PCT/EP2021/059790

§ 371 Date: Oct. 12, 2022

(30) Foreign Application Priority Data
Apr. 16, 2020 (DE) 102020110370.0

(51) Int. Cl. H01B 11/00; H01B 11/10

(52) U.S. Cl. CPC H01B 11/002; H01B 11/10

(57) ABSTRACT

A cable (100; 200) for electrically transmitting data includes two insulated line wires (110, 111), each of which has an inner conductor (110-1, 111-1) and which are stranded together in order to form a stranded line pair. A first dielectricum (130, 230) at least partly surrounds the two line wires (110, 111), and is at least partly arranged on the outer surface of the insulated line wires (110, 111). An interior at least partly enclosed by the first dielectricum (130) is partly filled with the stranded line pair. A second dielectricum (150) at least partly surrounds the first dielectricum (130; 230). A shielding (160, 170, 180) at least partly surrounds the second dielectricum (150). The first dielectricum (130; 230) is arranged at at least a specified distance (A) to the shielding (160).

### RELATED APPLICATIONS

This application filed under 35 U.S.C. § 371 is a national phase application of International Application Number PCT/EP2021/059790, filed Apr. 15, 2021, which claims the benefit of German Application No. 10 2020 110 370.0 filed Apr. 16, 2020, the subject matter of which are incorporated herein by reference in their entirety.

### TECHNICAL FIELD

The invention relates to a cable for electrically transmitting data.

### BACKGROUND

An example of a cable for electrically transmitting data is a twin axial cable (Twinax cable). The Twinax cable conventionally has a pair of inner conductors which are stranded with one another, an inner dielectric, a shielding or/and an outer conductor. A cable jacket encloses the above-mentioned components and finally insulates the cable from environmental influences. For the purpose of distinction, the inner conductors are bare or tin-plated. Damping differences are thereby obtained towards higher frequencies owing to the different surface conductivities of the inner conductors. A possible field of application is, for example, the low-loss transmission of symmetrical signals in computer or communication technology. Because of the construction without a separating foil between the inner conductors and the inner dielectric, “adhesion” of the wires and the inner dielectric can occur. However, the press fit without a separating foil can be established only with a very great leakage, the press fit denoting the force required to detach the foil in the region of the intersheath and the wire, that is to say in the region of the two insulating layers. Such a construction is thus disadvantageous in the automotive sector, in particular in the region of a supporting crimp.

A further example of a communication cable is known from document WO 2019/058 437 A1. The document describes a communication cable having a pair of stranded conductors, wherein each conductor has an inner conductor and an insulating sleeve. The stranded conductors are surrounded by a shielding which has thin braided metal wires and a foil, wherein the foil is arranged on an outer surface of the metal wires.

In such cables, the inner conductors are generally stranded with a predetermined strand lay length and strand lay direction, which results in a periodic change in the geometry. Corresponding to this change in the geometry, breakdowns in the transmission properties of the signals transmitted by the cable can occur. In particular, trouble-free transmission in the gigahertz range is not possible. The cables are further exposed to external influences, such as external forces, which result in bending or a lateral pressure. If such an external force exceeds a critical point, this results in a wire insulation of the cable collapsing and the transmission properties being disrupted or even destroyed. Furthermore, the field profile is then not guided optimally through the materials used for the cable, the fields being generated by the signals running in the cables.

There is therefore a need for an improved cable for electrically transmitting data and for the automotive sector. Accordingly, the object of the present invention is to provide an improved cable. In particular, the object of the present invention is to provide a cable which permits an increased cut-off frequency, or trouble-free transmission/improved transmission properties in an increased frequency range, and which at the same time has sufficient mechanical stability.

### SUMMARY OF THE INVENTION

According to a first aspect, a cable for electrically transmitting data is provided. The cable has two insulated line wires, each of which has an inner conductor and which are stranded with one another to form a line pair. The cable further has a first dielectric which at least partly surrounds the two line wires, wherein the first dielectric is arranged partly on outer surfaces of the insulated line wires. An interior space at least partly enclosed by the first dielectric is partly filled by the stranded line pair. The cable further has a second dielectric which at least partly surrounds the first dielectric, and a shielding which at least partly surrounds the second dielectric. The first dielectric is at at least a predetermined distance, A, from the shielding.

The mechanical aspects of the cable, which are desirable in particular in the automotive sector, are improved by the stranding. If the line wires were not stranded, they could more easily be moved in case of movement, and this could in turn lead to problems such as reduced transmission properties. By the provision of the second dielectric, a direct coupling between the line wires is increased in relation to a coupling between the line wires and the second dielectric. Thus, more field lines close without the involvement of the shielding, and the field strength in the part of the interior space that is not filled by the line wires is increased. By the provision of the first dielectric and of the at least partly enclosed interior space, improved mode conversion is achieved. By means of the proposed construction, the second dielectric allows a differential coupling to be produced. A/the symmetry in the line is thus present. The coupling is relocated between the line wires and not between the shielding and the line wires, which results in/contributes to the improved symmetry of the application.

The interior space is to be understood as being the spatial volume enclosed by the first dielectric. Because the cable has two end points at which it is connected, for example, to corresponding plug connectors, the interior space can be formed by an interlocking connection of the first dielectric with the corresponding plug connector. Alternatively, the first dielectric can be connected not in an interlocking manner, and a gas exchange between the interior space and the environment surrounding the cable can thus take place. This is also the case when the cable is simply cut at one end. The interior space is the space which extends along the cable longitudinal axis and is delimited by two opposing planes. These two planes are defined by the edges of the ends of the first dielectric.

The interior space can further have at least in part a space filled with gas. The gas can be air. The interior space can consist substantially of the stranded line pair and the gas-filled space.

The line wires can each be formed by a litz wire or a solid conductor. The line wires can also be referred to as conductor wires.

The second dielectric can completely surround or sheathe the first dielectric in a radial direction. If the point of contact of the two insulated line wires is viewed in the plane extending transverse to the cable longitudinal axis, radial can be understood as meaning any half-line that is guided outward from this midpoint. The first dielectric has an inner surface (inner contour) which faces the two insulated line wires, and an outer surface (outer contour), wherein the outer surface of the first dielectric faces an inner surface (inner contour) of the second dielectric. The inner surface of the second dielectric can be in direct contact with the outer surface of the first dielectric and/or adhere thereto. Surrounding or sheathing of the second dielectric by the first dielectric is to be understood as meaning that a portion of the second dielectric is arranged opposite a portion of the first dielectric in the radial direction. In particular, the first dielectric and the second dielectric can be in the form of layers arranged on one another. This definition relating to surrounding or sheathing also applies to the realization hereinabove or hereinbelow of other elements of the cable, unless mentioned otherwise.

The first dielectric can have an elliptical cross-sectional shape, wherein the elliptical cross-sectional shape extends within a plane which extends substantially orthogonal to a cable longitudinal axis. The elliptical cross-sectional shape, when seen along the cable longitudinal axis, co-rotates owing to the stranding of the line wires.

Furthermore, an inner contour of the second dielectric can be formed in an interlocking manner with an outer contour of the first dielectric and thereby retain the cross-sectional shape of the first dielectric. The outer contour of the second dielectric is thereby circular, in order to achieve improved assembly.

Each line wire can have a circular cross-sectional shape with a geometric center, wherein the circular cross-sectional shape extends within a plane which extends substantially orthogonal to the cable longitudinal axis. Owing to the stranding of the line wires, tilting of the circular cross-sectional shape relative to the cable longitudinal axis can result. In other words, the circular cross-sectional shape is no longer orthogonal to the cable longitudinal axis because the normal vector of the circular cross-sectional shape is in this case tilted with respect to the cable longitudinal axis. The circular cross-sectional shape can extend in the same plane as the elliptical cross-sectional shape. The geometric centers of the line wires can be arranged on a major axis of the elliptical cross-sectional shape and symmetrically with respect to a minor axis of the elliptical cross-sectional shape.

The elliptical cross-sectional shape can have two opposing vertices along each of the major axis and the minor axis, wherein the two vertices of the major axis form a path with a first predetermined length and the two vertices of the minor axis form a path with a second predetermined length. A ratio of the first predetermined length to the second predetermined length is at least 1.4 to 1, for example 1.7:1, in particular 2:1.

As a result of the elliptical cross-sectional shape, the fields are guided particularly well and on the shortest path without loss between the first dielectric and the free space of the at least partly filled interior space.

Alternatively, the first dielectric can form the interior space in a plane extending orthogonal to a cable longitudinal axis by two side portions arranged parallel to one another and two semicircular portions. In each case one semicircular portion is arranged at least partly along the outer surface of one of the insulated line wires.

The two side portions arranged parallel to one another are arranged between the two semicircular portions and end therewith so as to form the interior space.

Consequently, a shape similar to the elliptical cross-sectional shape is achieved, which likewise guides the fields particularly well and on the shortest path. The above-mentioned embodiments of the elliptical cross-sectional shape and also the mentioned geometric or length ratios apply also to the shape similar to the elliptical cross-sectional shape.

A strand lay length of the first dielectric can correspond to from 0.4 to 0.9, for example 0.7, of a strand lay length or substantially to the strand lay length of the insulated line wires. For example, the strand lay length of the first dielectric can correspond to 0.43 of the strand lay length of the insulated line wires. In other words, a (foil) pitch of the first dielectric can correspond to from 0.4 to 0.9, for example 0.7, of the strand lay length or substantially to the strand lay length of the insulated line wires. For example, the (foil) pitch of the first dielectric can correspond to 0.43 of the strand lay length of the insulated line wires (e.g. in the case of a (foil) pitch of 13 mm and a strand lay length of the line wires of 30 mm). The first dielectric can thereby be in the form of a strip or an insulating film. The first dielectric can thereby be wound with the opposite lay based on the strand lay direction of the insulated line wires. By winding with the opposite lay it is achieved that, in the overlapping region, the first dielectric does not “fall” into the interior space, and that two adjacent layers of the first dielectric are in contact in the overlapping region. This is also attributable to the support points of the first dielectric on the line wires. With the opposite lay is here to be understood as meaning that the strand lay direction of the first dielectric does not coincide with the strand lay direction of the line wires but is in the opposite direction. The strip or the insulating film can be wound around the insulated line wires such that the strip or the insulating film extends along a strip/insulating film direction of extent and has a width extending orthogonal to this strip/insulating film direction of extent, wherein the width of the first dielectric corresponds to from 0.2 to 0.7, for example from 0.3 to 0.65, of the strand lay length of the line wires. The individual windings of the first dielectric can in each case have an overlapping region of from 5 to 50%.

In this context, the term (strand) lay length has its meaning conventional in the technical field of electric cables of the lead, measured parallel to the longitudinal axis of the cable, of a wire in the case of a complete turn about the longitudinal axis. The (foil) pitch is the product feed per complete turn when viewed parallel to the longitudinal axis of the cable. Thus, the terms strand lay length and (foil) pitch, at least in some exemplary embodiments, can be understood as meaning the same. Moreover, the expressions (radially) inner/outer and inner side/surface and outer side/surface here always relate to the cable longitudinal axis, unless indicated otherwise. All the lay directions mentioned herein further relate to the same direction of extent along the cable. In other words, the term strand lay direction refers to the lay directions when the cable is viewed from the same perspective along the cable longitudinal axis.

Each of the line wires can be at least partly surrounded by a third dielectric so as to insulate the line wires from one another. By means of the third dielectric, the line wires are each insulated, or the insulated line wires are formed. The word “insulated” in the expression “insulated line wires” means that the line wires are insulated by means of an element or a coating, here are insulated by means of the third dielectric. In other words, a respective line wire has an inner conductor and a third dielectric at least partly surrounding the inner conductor. The third dielectric can have a relative permittivity of from 1.2 to 2.5, for example from 1.4 to 2.3, and/or a loss factor of 5×10e−4. These values result in particular in a reduced transmission loss of the cable.

The relative permittivity ϵᵣ of a medium, also called the dielectric constant, is the dimensionless ratio of its permittivity ϵ to the permittivity ϵ₀ of the vacuum: ϵᵣ=ϵ/ϵ₀. The relative permittivity is a measure of the field-weakening effects of the dielectric polarization of the medium. The loss factor indicates how great the losses are in electrical components such as inductors and capacitors or on propagation of electromagnetic waves in material (e.g. air). “Loss” means the energy which is converted electrically or electromagnetically and is converted, for example, into heat (dissipation). The electromagnetic wave is damped by these losses. In other words, the dielectric loss factor indicates the amount of energy an insulating material absorbs in the alternating field and converts into lost heat. The permittivity and the loss factor are frequency-dependent and the indicated values relate to the frequency range of the signal spectrum.

In particular, the third dielectric can have a relative permittivity which corresponds to a relative permittivity of the second dielectric. The first dielectric can thereby have the same material as the third dielectric. Despite the same permittivity or the same material, different transit times between differential modes and common modes are achieved by the first and the third dielectric.

The first dielectric can have a relative permittivity of from 1.8 to 3.5, for example from 2.0 to 3.3.

The predetermined distance can be at least 0.15 mm, for example from 0.3 to 0.6 mm. The choice of the predetermined distance is significant for the capacitance between the insulated line wires, and sufficiently good capacitive decoupling is achieved with the predetermined distance of at least 0.15 mm. The transmission behavior is improved even further by a predetermined distance of from 0.3 to 0.6 mm.

The second dielectric can have a relative permittivity of from 1.3 to 2.8, for example from 1.5 to 2.5. Alternatively or additionally, the second dielectric can be formed by extrusion.

The shielding can have a plastics foil with a metal-clad inner and/or outer side, which is formed on the outer surface of the second dielectric. Alternatively or additionally, the shielding can further have a braided shield, which is arranged on the metal-clad outer side or on the outer surface of the plastics film without metal cladding. The braided shield covers at least from 50 to 92%, for example from 75 to 89%, of the outer side of the plastics foil. In other words, the shielding can consist of a metal-coated foil with a metal layer on the outer side of the foil, wherein a braided shield can further be arranged over this metal layer. The shielding can generally be in the form of a shielding foil. The shielding foil can be a metal-clad, for example aluminum-clad, foil.

With these coverage values, maximum tensile strength of the cable is achieved, while the cable at the same time has good flexibility. The resonances that develop can be controlled via the number of line wires and the pitch of the braiding (ratios of the strand lay length of the first dielectric to the strand lay length of the line wires or, conversely, ratios of the strand lay length of the line wires to the strand lay length of the first dielectric). The overlapping/covering of the braided structure, for example, is important therefor. The shield coverage indicates how high the shielding effect is.

The shielding can have a layer formed by extrusion, which at least partly surrounds at least the plastics foil or the plastics foil and the braided shield. The shielding can be electrically conductive/conducting. The shielding can protect the elements seen/located within/in the radial direction of the cable from electromagnetic influences (partially conducting shielding and/or partially conducting jacket).

The plastics foil can consist of polypropylene or polyethylene terephthalate.

The braided shield can consist of copper wires running parallel to one another. Depending on the desired temperature range, the copper wires can be passivated by a tin layer. In particular, in the case of a continuous operating temperature of 100° C. or more, the copper wires can be passivated by a tin coating, or by the tin layer.

The second dielectric can consist of polypropylene.

The first, the second and/or the third dielectric can be in the form of an insulating film or in the form of an insulating foil.

The first dielectric can consist of a high-frequency-, HF-, suitable material. The suitable material can comprise polypropylene. The use of polypropylene makes it possible to achieve improved adhesion stability and improved symmetry of the cable. The permittivity of polypropylene is similar to that of the first dielectric and leads to a reduction in interference. The loss factor of polypropylene is similar to that of the first dielectric and leads to a reduction in interference.

The two insulated line wires/conductor wires can be stranded with one another in a strand lay direction with a strand lay length, wherein the first dielectric is wound around the two insulated line wires/conductor wires in or contrary to the strand lay direction.

By winding in or contrary to the strand lay direction, the partly filled interior space can be formed in a simple manner. In particular, the elliptical cross-sectional shape or the cross-sectional shape similar to the elliptical cross-sectional shape can thus be achieved in a simple manner. By winding in the strand lay direction, the proportion of the interior space which is not filled can be reduced and is smaller compared to winding contrary to the strand lay direction.

Further features, properties, advantages and possible modifications will become apparent to a person skilled in the art from the following description, in which reference is made to the accompanying drawings. In the drawings, the figures show, schematically and by way of example, a cable for electrically transmitting data. All the features that are described and/or depicted in the drawings show the subject-matter disclosed herein on their own or in any desired combination. The dimensions and proportions of the components shown in the figures are not to scale.

### BRIEF DESCRIPTION OF THE FIGURES

FIG. 1 shows a cross-section through a cable for electrically transmitting data according to a first exemplary embodiment; and

FIG. 2 shows a cross-section through a cable for electrically transmitting data according to a second exemplary embodiment.

### DETAILED DESCRIPTION

Components and features which are comparable or identical and have the same effect are in each case provided with the same reference numerals in the figures.

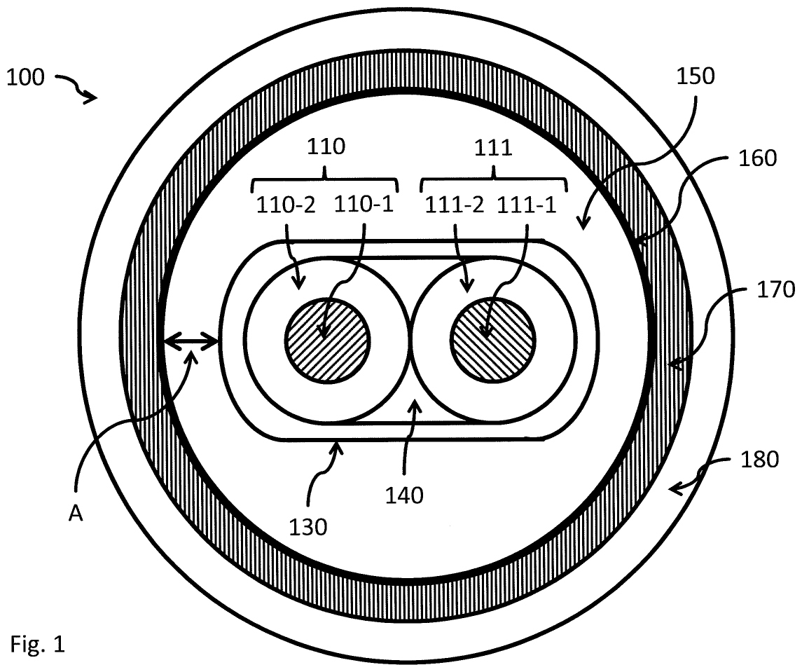

FIG. 1 shows, schematically, a first exemplary embodiment of a cable 100 for electrically transmitting data in the form of a cross-section through the cable 100. The cross-section through the cable 100 extends within a plane extending orthogonal to a cable longitudinal axis of the cable 100.

The cable 100 has two insulated line wires 110, 111 which are stranded with one another and form a stranded line pair. The two insulated line wires 110, 111 are surrounded or enclosed by a first dielectric 130. The first dielectric 130 has a substantially constant wall thickness. If the first dielectric 130 is wound around the line wires 110, 111, as will be described below, the first dielectric 130 can have double the wall thickness in overlapping regions. The individual windings can thereby partly overlap, which is to be understood as being an overlapping region. The wall thickness is a length which extends within the plane of the drawing or within the plane defined above and which indicates a distance between two opposite portions of an inner and outer side/surface of the first dielectric 130. The wall thickness is the shortest connection from the inner side to the outer side. The first dielectric 130 forms/delimits an interior space in which the two insulated line wires 110, 111 are arranged. As is shown in FIG. 1, the two insulated line wires 110, 111 occupy only part of the interior space and a free space 140 remains between the insulated line wires 110, 111 and the first dielectric 130. The free space 140 can be filled with gas/gas-filled, for example with air. Signals are conducted through the insulated line wires 110, 111. The signals generate one or more fields.

The first dielectric 130 shown in FIG. 1 has a cross-sectional shape which is similar to an ellipse. The cross-sectional shape thereby extends in a plane extending orthogonal to the cable longitudinal axis. The cross-sectional shape of the first dielectric 130 has two side portions arranged substantially in parallel and two substantially semicircular portions. The two parallel side portions are arranged opposite one another and are spaced apart from one another by a predetermined distance from a cable midpoint of the cable. Furthermore, in each case one of the two semicircular portions is arranged at least partly along the outer surface of one of the two line wires. A radius of a semicircular portion thereby corresponds substantially to a radius of the circular cross-section of the insulated line wires 110, 111 or is only slightly larger than that radius, so that the semicircular portion at least partly rests against the outer surface of the insulated line wires 110, 111 or encloses or surrounds the insulated line wires. The two parallel side portions are arranged between the two semicircular portions and connect the respective ends of the semicircular portions so as to form a continuous jacket for the two line wires 110, 111. The interior space of the first dielectric 130 is thus formed in cross-section.

The cable 100 further has a second dielectric 150 in the form of an intersheath which at least partly surrounds the first dielectric 130. The first dielectric 130 has an inner surface which faces the two insulated line wires 110, 111, and an outer surface. The outer surface of the first dielectric 130 faces an inner surface of the second dielectric 150. According to the cross-section shown in FIG. 1, the second dielectric 150 completely surrounds the first dielectric 130. The second dielectric 150 has a substantially circular cross-section or a substantially circular outer contour, wherein the first dielectric 130 is arranged together with the insulated line wires 110, 111 substantially centrally within the second dielectric 150. Owing to the elliptically similar, that is to say similar to an ellipse, cross-sectional shape of the first dielectric 130, the second dielectric 150 has a varying wall thickness so as to form the circular cross-section.

The cable 100 further has a shielding 160, 170, 180 which at least partly surrounds or encloses the second dielectric 150. According to the cross-section shown in FIG. 1, the shielding 160, 170, 180 completely surrounds the second dielectric 150. An outer surface of the second dielectric 150 faces an inner surface of the shielding 160, 170, 180. In particular, the shielding has a plastics foil 160, which at least partly encloses the outer surface of the second dielectric 150. The plastics foil 160 leads to improved stability of the cable 100. The plastics foil 160 has a metal-clad inner and/or outer side or surface.

By the provision of the second dielectric 150, a direct coupling between the line wires 110, 111 is increased in relation to a coupling between the line wires 110, 111 and the second dielectric 150. Thus, more field lines close without the involvement of the shielding 160, 170, 180, and the field strength in the part of the interior space that is not filled by the line wires 110, 111 is increased.

The shielding further has a braided shield 170 which is arranged on the outer surface of the plastics foil 160 and at least partly surrounds or encloses it. The braided shield 170 thereby covers at least from 50 to 92%, for example from 75 to 89%, of the outer side/outer surface of the plastics foil 160. The shielding further has a layer 180 formed by extrusion, which forms an outermost layer of the cable 100. The layer 100 at least partly surrounds the plastics foil 160. According to FIG. 1, the layer 180 surrounds an outer surface of the braided shield 170, wherein an inner surface of the braided shield 170 faces the outer surface of the plastics foil 160. Thus, the braided shield 170 is arranged between the plastics foil 160 and the layer 180. The plastics foil 160 can consist of polypropylene or polyethylene terephthalate. The braided shield 170 can consist of copper wires running parallel to one another. The copper wires running parallel to one another can further be braided with one another so as to form the braided shield 170.

As is shown in FIG. 1, the first dielectric 130 is at a predetermined distance A from the plastics foil 160. This predetermined distance A is greater than zero. In other words, a minimum wall thickness of the second dielectric 150 corresponds to the predetermined distance A. According to FIG. 1, the two midpoints of the line wires 110, 111 are arranged on a path which runs parallel to the two parallel portions of the first dielectric 130 and is arranged between these two parallel portions. In order to achieve a circular cross-sectional shape of the second dielectric 150, the wall thickness along this path corresponds to the predetermined distance A. The wall thickness of the second dielectric 150 is greatest along a path which is orthogonal to that path and extends through the midpoint of the cable 100. The predetermined distance A is at least 0.15 mm, for example from 0.3 to 0.6 mm. By spacing the plastics foil 160 apart from the first dielectric 130 by the predetermined distance A, improved capacitive decoupling of the two line wires 110, 111 from the shielding 160, 170, 180, which functions as an electrical reference, is achieved. The above-described sizes, in particular the wall thickness, relate to the cross-sections shown in the figures, which do not show any overlapping of the individual dielectrics or shields. It will be appreciated by the person skilled in the art that the wall thickness can double in overlapping regions.

Each of the line wires 110, 111 further has an inner conductor 110-1, 111-1 and a third dielectric 110-2, 111-2. In each line wire 110, 111, the third dielectric 110-2, 111-2 at least partly encloses or surrounds the inner conductor 110-1, 111-1. The third dielectric 110-2, 111-2 can be in the form of an insulating sleeve. By means of the third dielectric 110-2, 111-2, the two inner conductors 110-1, 111-1 and thus the two line wires 110, 111 are insulated from one another.

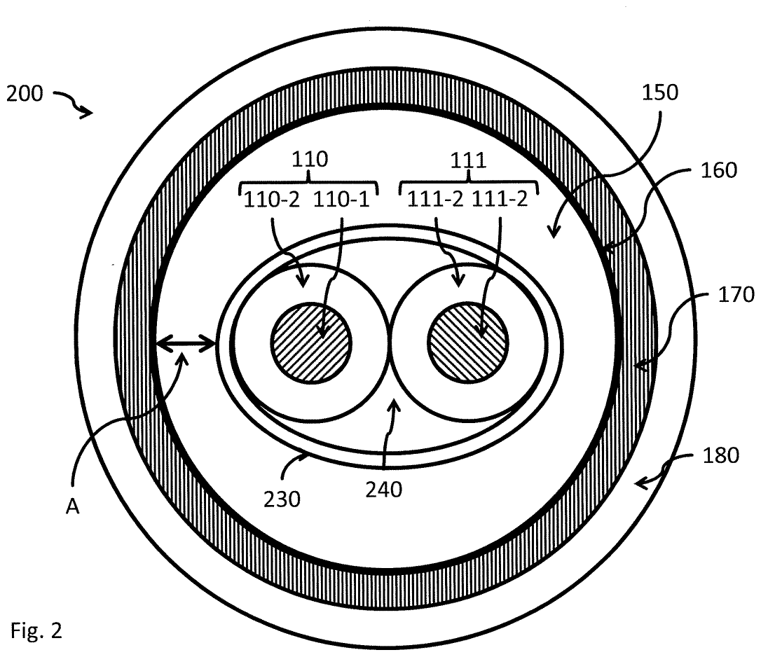

FIG. 2 shows a cable 200 in which, in contrast to the cable 100 of FIG. 1, the first dielectric 230 has a substantially elliptical cross-sectional shape. This elliptical cross-sectional shape extends in a plane orthogonal to the cable longitudinal axis. Similarly to the first dielectric 130 of the cable 100 in FIG. 1, the first dielectric 230 of the cable 200 has the two line wires 110, 111 and a free space 240. The elliptical cross-sectional shape has a major axis and a minor axis which are orthogonal to one another. An ellipse generally has four vertices, wherein in each case two vertices are arranged on the major axis and two vertices are arranged on the minor axis. According to FIG. 2, the two vertices of the major axis are spaced further apart from the origin, or the midpoint, of the elliptical cross-sectional shape than the two vertices of the elliptical cross-sectional shape on the minor axis. The geometric centers of the line wires 110, 111 or of the inner conductors 110-1, 111-1 are arranged on the major axis and are at the same distance from the midpoint of the elliptical cross-sectional shape. Thus, the centers of the line wires 110, 111 are arranged symmetrically with respect to the minor axis. A first path which connects the two vertices on the major axis has a first predetermined length, and a second path which connects the two vertices on the minor axis has a second predetermined length. A specific form of the elliptical cross-sectional shape is formed with a ratio of the first predetermined length to the second predetermined length of at least 1.4 to 1, for example 1.7 to 1, and in particular 2 to 1. With such a form of the elliptical cross-sectional shape, the fields generated by the signals in the line wires 110, 111 are guided virtually without loss over the shortest path.

The following aspects of the invention can apply both to the cable 100 according to FIG. 1 and to the cable 200 according to FIG. 2.

The line wires 110, 111 of the cable 100, 200 can be stranded with one another with a predetermined strand lay length and strand lay direction. A strand lay length of the first dielectric 130, 230 can correspond to from 0.4 to 0.9, for example 0.7, of a strand lay length of the line wires 110, 111. For example, the strand lay length of the first dielectric 130, 230 can correspond to 0.43 of the strand lay length of the insulated wires 110, 111. In other words, a (foil) pitch of the first dielectric 130, 230 can correspond to from 0.4 to 0.9, for example 0.7, of the strand lay length or substantially to the strand lay length of the insulated line wires 110, 111. For example, the pitch of the first dielectric 130, 230 can correspond to 0.43 of the strand lay length of the insulated line wires 110, 111. By means of such a ratio of the strand lay lengths, a cross-sectional shape similar to the ellipse or an elliptical cross-sectional shape of the cross-section of the first dielectric 130, 230 is achieved in a particularly simple manner during production. The first dielectric 130, 230 can be wound around the two insulated line wires 110, 111 in or contrary to the strand lay direction.

The first dielectric 130, 230 can be an insulating film which has a strip/insulating film direction of extent and a width extending orthogonal thereto. Orthogonal to the width and the strip/insulating film direction of extent, the insulating film has a constant thickness, which, however, is small compared to a length along the strip/insulating film direction of extent and the width. The width can correspond to from 0.2 to 0.7, for example from 0.3 to 0.65, of the strand lay length of the line wires 110, 111. With these parameters, the first dielectric 130, 230 at least partly encloses the outer surface of the line wires 110, 111 and thus is substantially supported on this part-surface. The first dielectric 130 can be wound around the line wires 110, 111 such that overlapping regions of the first dielectric 130 are formed between the individual turns of the first dielectric 130, in order thus to form an interior space 140, 240 which is closed when viewed in cross-section.

The third dielectric 110-2, 111-2 can have a relative permittivity of from 1.2 to 2.5, for example from 1.4 to 2.3, or/and a loss factor of 5×10^{e-4}. A reduced transmission loss of the cable 100, 200 can be achieved by means of these values.

The third dielectric 110-2, 111-2 can have a relative permittivity which corresponds to the relative permittivity of the second dielectric 150. Furthermore, the predetermined distance A and the relative permittivity are significant for the capacitance between the line wires 110, 111, and low values are to be strived for. Such a low capacitance value is achieved in particular in the case of a combination with a predetermined distance A of 0.15 mm, for example from 0.3 to 0.6 mm.

The first dielectric 130, 230 can have a relative permittivity of from 1.8 to 3.5, for example from 2.0 to 3.3.

The second dielectric 150 can have a relative permittivity of from 1.3 to 2.8, in particular from 1.5 to 2.5. Alternatively or additionally, the second dielectric 150 can be formed by extrusion. Additionally or alternatively, the second dielectric 150 can consist of polypropylene.

The first, the second or/and the third dielectric 130, 230, 150, 110-2, 111-2 can be an insulating film.

It will be appreciated that the exemplary embodiments explained hereinbefore are not conclusive and do not limit the subject-matter disclosed herein. In particular, it will be apparent to the person skilled in the art that he can combine the described features with one another as desired and/or can omit different features without departing from the subject-matter disclosed herein.

1. A cable (100; 200) for electrically transmitting data, having:
two insulated line wires (110, 111), each of which has an inner conductor (110-1, 111-1) and which are stranded with one another to form a stranded line pair;
a first dielectric (130; 230) which at least partly surrounds the two insulated line wires (110, 111), wherein the first dielectric (130) is arranged partly on outer surfaces of the insulated line wires (110, 111), and wherein an interior space at least partly enclosed by the first dielectric (130) is partly filled by the stranded line pair;
a second dielectric (150) which at least partly surrounds the first dielectric (130; 230); and
a shielding (160, 170, 180) which at least partly surrounds the second dielectric (150),
wherein the first dielectric (130; 230) is at at least a predetermined distance (A) from the shielding (160).

2. The cable (100; 200) as claimed in claim 1, wherein
the second dielectric (150) completely surrounds or encloses the first dielectric (130; 230) in the radial direction.

3. The cable (200) as claimed in claim 1, wherein
the first dielectric (230) has an elliptical cross-sectional shape, wherein the elliptical cross-sectional shape extends within a plane which extends substantially orthogonal to a cable longitudinal axis.

4. The cable (200) as claimed in claim 3, wherein
each insulated line wire (110, 111) has a circular cross-sectional shape with a geometric center, wherein the circular cross-sectional shape extends within a plane which extends substantially orthogonal to the cable longitudinal axis,
the geometric centers of the insulated line wires (110, 111) are arranged on a major axis of the elliptical cross-sectional shape and symmetrically with respect to a minor axis of the elliptical cross-sectional shape.

5. The cable (200) as claimed in claim 3, wherein
the elliptical cross-sectional shape has two opposing vertices along each of the major axis and the minor axis,
the two vertices of the major axis form a path with a first predetermined length and the two vertices of the minor axis form a path with a second predetermined length,
a ratio of the first predetermined length to the second predetermined length corresponds at least to 1.4 to 1, for example 2:1.

6. The cable (100) as claimed in claim 1, wherein
the first dielectric (130) forms the interior space in a plane extending orthogonal to a cable longitudinal axis by two side portions arranged parallel to one another and two semicircular portions,
in each case one semicircular portion is arranged at least partly along the outer surface of one of the insulated line wires (110, 111), and
the two side portions arranged parallel to one another are arranged between the two semicircular portions and end therewith so as to form the interior space.

7. The cable (100; 200) as claimed in claim 1, wherein
a strand lay length of the first dielectric (130; 230) corresponds to from 0.4 to 0.9, for example 0.7, of a strand lay length of the stranded line pair, or the strand lay length of the first dielectric (130; 230) corresponds to the strand lay length of the stranded line pair, or/and
the first dielectric is formed in the form of a strip or an insulating film which is wound around the stranded line pair,
the strip or the insulating film extends along a strip/insulating film direction of extent and has a width extending orthogonal to this strip/insulating film direction of extent, wherein the width of the first dielectric corresponds to from 0.2 to 0.7, for example from 0.3 to 0.65, of the strand lay length of the stranded line pair.

8. The cable (100; 200) as claimed in claim 1, wherein
each line wire (110, 111) is at least partly surrounded by a third dielectric (110-2, 111-2) so as to insulate the line wires (110, 111) from one another, the third dielectric (110-2, 111-2) has a relative permittivity of from 1.2 to 2.5, for example from 1.4 to 2.3.

9. The cable (100; 200) as claimed in claim 8, wherein
the third dielectric (110-2, 111-2) has a relative permittivity which corresponds to a relative permittivity of the second dielectric (150).

10. The cable (100; 200) as claimed in claim 1, wherein
the first dielectric (130; 230) has a relative permittivity of from 1.8 to 3.5, for example from 2.0 to 3.3, or/and
the predetermined distance (A) is at least 0.15 mm, for example from 0.3 to 0.6 mm.

11. The cable (100; 200) as claimed in claim 1, wherein
the second dielectric (150) has a relative permittivity of from 1.3 to 2.8, for example from 1.5 to 2.5, or/and
wherein the second dielectric (150) is formed by extrusion.

12. The cable (100; 200) as claimed in claim 1, wherein
the shielding has a plastics foil (160) with a metal-clad inner and/or outer side, which is formed on the outer surface of the second dielectric (150), or/and
the shielding further has a braided shield (170), which is arranged on the metal-clad outer side or on the outer side of the plastics foil (160) without metal cladding, and
the braided shield (170) covers at least from 50 to 92%, for example from 75 to 89%, of the outer side of the plastics foil (160).

13. The cable (100; 200) as claimed in claim 1, wherein
the shielding (160, 170) has a layer (180) formed by extrusion, which at least partly surrounds at least the plastics foil (160), or/and
the plastics foil (160) consists of polypropylene or polyethylene terephthalate, or/and
the braided shield (170) consists of copper wires running parallel to one another.

14. The cable (100; 200) as claimed in claim 1, wherein
the second dielectric (150) consists of polypropylene, or/and
the first, the second or/and the third dielectric (130, 150, 110-2, 111-2) is an insulating film.

15. The cable (100; 200) as claimed in claim 1, wherein
the two insulated line wires (110, 111) are stranded in a strand lay direction with a strand lay length so as to form the stranded line pair,
the first dielectric (130; 230) is wound around the stranded line pair in or contrary to the strand lay direction.
